(19) United States
(12) Patent Application Publication
(10) Pub. No.: US 2002/0053165 A1
(43) Pub. Date: May 9, 2002

(54) Safety locking device for secure prison cells

(76) Inventors: James M. Secoolish, Scranton, PA (US); Lester Barnes, Homosassa, FL (US)

Correspondence Address: BAKER & DANIELS, 205 W. JEFFERSON BOULEVARD, SUITE 250, SOUTH BEND, IN, 46601, US

(21) Appl. No.: 09/920,513

(22) Filed: Aug. 1, 2001

Related U.S. Application Data
(60) Provisional application No. 60/247,303, filed on Nov. 9, 2000.

(51) Int. Cl. E05B 47/00

(52) U.S. Cl. 49/15

(57) ABSTRACT

A safety-locking device is disclosed which is usable with a manual override system in a secure prison cell. The safety locking device is cooperable with the existing crank mechanism and geared together such that upon turning of the crank mechanism, the locking device rotates to a locked position corresponding to the position where the individual cells can be keyed open. The safety locking device is comprised of a small drive gear which is driven by said crank mechanism, and a large driven gear or sprocket driven by the small gear, by way of a chain. A locking mechanism has a locking plunger spring loaded against the back of the larger gear such that upon reaching the position where the individual cells can be keyed open, a locking plunger locks the larger driven gear and crank mechanism from further rotation. A release mechanism allows for further rotation.

### BACKGROUND OF THE INVENTION

1. Field of the Invention

The invention relates to a security device for a prison cell run, and in particular, where the cell run includes a manual override cell unlocking device, the security device prevents moving the manual override from a position allowing individual doors to be unlocked, to a position in which all doors are opened.

2. Discussion of the Prior Art

In a secure prison, the security of both the prison mates as well as the prison guards is of utmost concern. Normally in secure prisons, secure cells are positioned side by side in a row, commonly referred to as a cell run. Various different security systems and locking devices are available and usable with such a cell run. While most secure doors operate under the influence of electric power, manual override systems are available in the case of loss of power. For example, in the case of a power outage or fire, where the electric power and electronics are not operating, a manual unlocking system is available which allows for the individual doors of a cell run to be manually opened either in a position where a single door can be keyed opened, or where an entire cell run is opened.

One such system in particular, uses a control box at the end of the cell run, which has a crank mechanism similar to a bolt head, which must be turned to release the individual cells. This crank mechanism is in turn interconnected to a linkage system, and in particular to a cable which runs above the individual cell blocks. The crank mechanism is designed such that, if the crank mechanism is turned a certain number of rotations, for example, three rotations, the cable is pulled which operates the lock mechanism above the individual doors, and allows individual doors to then be unlocked at the proximity of the door to be opened. Alternatively, if all of the doors are desired to be opened, the crank is rotated to another location, for example, to a position of seven rotations total, which will unlock all the doors. This will then allow all individual doors in a cell run to be slidably opened. While much design effort has been focused on the efficiency and security of the locking mechanism which is positioned above the individual security doors in a cell run, see, for example, U.S. Pat. Nos. 4,621,451; 4,982,528; and 4,641,458, incorporated herein by reference, no focus has been placed on the human factors error which can occur in an emergency situation in a secure prison. For example, in the case of an emergency where no power exists in the prison, if the security guard is under extreme pressure, or if not adequately trained, he or she could either miscount the number of rotations that he or she has completed, or could simply be in error. This places the security guard in extreme danger as, instead of a single cell door being in a position where it can be unlocked, the entire cell run is unlocked and all doors can be slidably opened.

The subject invention is intended to overcome such shortcomings in the prior art.

### SUMMARY OF THE INVENTION

The objects of the invention have been accomplished by providing a safety device for a secure prison cell, or the like, for use with a manual override cell unlocking device having a crank mechanism, which upon a first select number of rotations, allows individual doors to be unlocked, and upon continued rotation to a second select number of rotations, to unlock an entire cell run. The device prevents inadvertent unlocking of a plurality of cells in a cell run by over rotation of the crank, and comprises a driven member cooperable with the crank mechanism and a lock mechanism cooperable with the driven member having a locked position coinciding with the first select number of rotations of the crank mechanism, which locks the crank mechanism from further rotation. A release member allows the crank mechanism to be further rotated.

In the preferred embodiment of the invention, the driven member is a gear member, and is driven by the crank mechanism. Also preferably, a drive gear is coupled to the crank mechanism for driving the driven gear. Preferably, the drive gear and driven gear are rotary sprockets, and are driven by a chain in surrounding relation to the drive and driven sprockets. Preferably, the drive and driven gears are driven in a 5:1 ratio. The lock mechanism is spring loaded against the driven gear, and is comprised of a spring-loaded member locked against a locking shoulder of the driven gear. Preferably, the spring loaded member is a rod, spring loaded against the driven gear, and the locking shoulder is formed by an aperture through the driven gear, which receives the rod, when the rod and aperture are aligned.

In the preferred version of the invention, the lock mechanism is comprised of a spring-loaded member locked against the driven member. Also preferably, the driven member is a driven gear, and the spring-loaded member is a rod, spring loaded against the driven gear. Preferably, the driven gear has an aperture therethrough, which receives the rod, when the rod and aperture are aligned.

In another aspect of the invention, a secure prison cell comprises a plurality of cells in a cell run, where each cell has a secure and slidable door. A manual override cell unlocking device has a crank mechanism interconnected by way of a linkage assembly to the doors, the crank mechanism being operable so that upon a first select number of rotations, individual doors may be unlocked, and upon continued rotation to a second select number of rotations, the entire cell run is unlocked. A safety device is provided which is cooperable with the crank mechanism for locking the crank mechanism upon reaching the first select number of rotations, preventing inadvertent unlocking of a plurality of cells in a cell run by over rotation of the crank mechanism.

In yet another embodiment of the invention, a manual override assembly is provided for a plurality of secure doors for a prison cell run, and comprises a linkage assembly connected to the doors, having a first linear position allowing the doors to be manually unlocked, and a second linear position which unlocks all of the doors. A crank mechanism is interconnected to the linkage assembly and is operable so that upon a first select number of rotations, the linkage assembly is pulled to the first position, and upon continued rotation to a second select number of rotations, the linkage is moved to the second linear position and the entire cell run is unlocked. A safety device is cooperable with the crank mechanism for locking the crank mechanism upon reaching the first select number of rotations, preventing inadvertent over rotation of the crank mechanism. Finally, a release mechanism is provided for unlocking the safety device and for allowing further rotation thereof.

### BRIEF DESCRIPTION OF THE DRAWINGS

FIG. 1 is a perspective view of a cell run of any given length showing the manual control box at the end of the cell run;

FIG. 2 shows a front plan view of the safety device according to the preferred embodiment of the invention;

FIG. 3 shows a top plan view of the assembly of FIG. 2;

FIG. 4 shows a left-hand side view of the safety device from the left-hand view shown in FIG. 3;

FIG. 5 is a right-hand view as viewed from the right side of FIG. 3; and

FIG. 6 is a rear view of the device as depicted in FIG. 3.

### DETAILED DESCRIPTION OF THE PREFERED EMBODIMENT

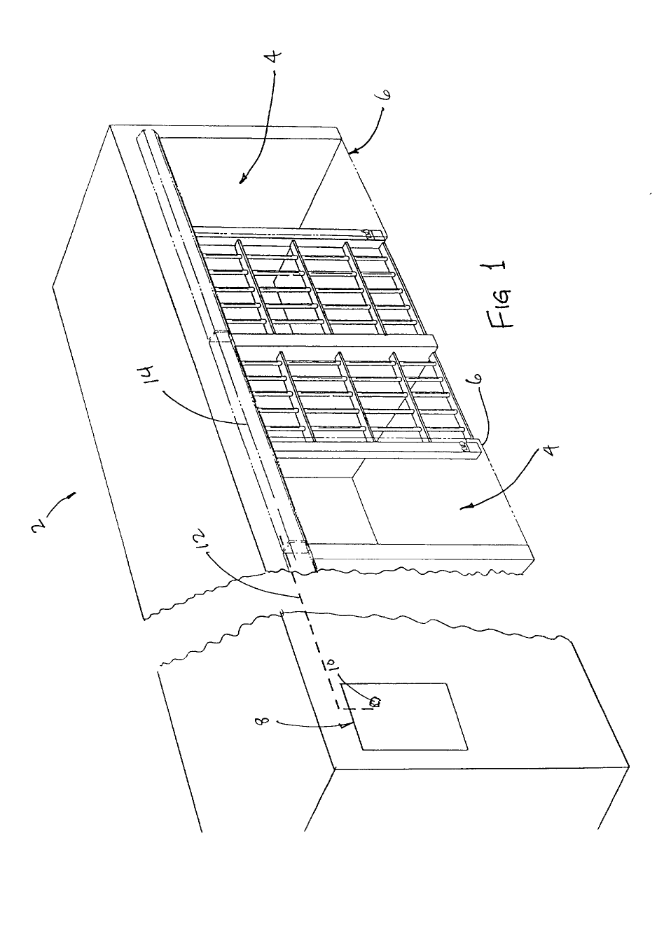

With reference first to FIG. 1, a cell run is shown generally at 2 which comprises a plurality of individual secure cells 4 having individual slidable doors which are shown in phantom as 6. A manual override assembly is shown generally at 8 at the end of the cell run which includes a crank member shown generally at 10. The crank member is connected internally to a linkage, for example, a cable, shown in phantom at 12, and is pulled leftwardly through a channel 14 as viewed in FIG. 1 as the crank mechanism 10 is rotated. This cable 12 is positioned within the channel 14 above the individual cells, and is interconnected to a locking assembly, which can take on a plurality of configurations, one of which is shown in U.S. Patent 4,621,451 incorporated herein by reference.

This manual override assembly 8 is configured such that, for a first given number of rotations, for example, 2-3 rotations, the cable 12 is pulled linearly such that the lock assembly within the channel 14 moves to a position such that any of the individual cells 4 can be opened by a further keying mechanism at any given individual cell. The manual override assembly is also profiled such that for a second given number of rotations, for example, 7 rotations, the cable 12 is pulled to the extent where the locking assembly above all of the cells 4 in the individual run 2 are freed, allowing all of the individual cell doors to be slidably opened. It should be understood that the number of rotations is arbitrary and should not so limit the invention, as the individual manufacturers of the override systems design this number in. Rather, it is only important to note that the present design should accommodate the various alternatives in existence.

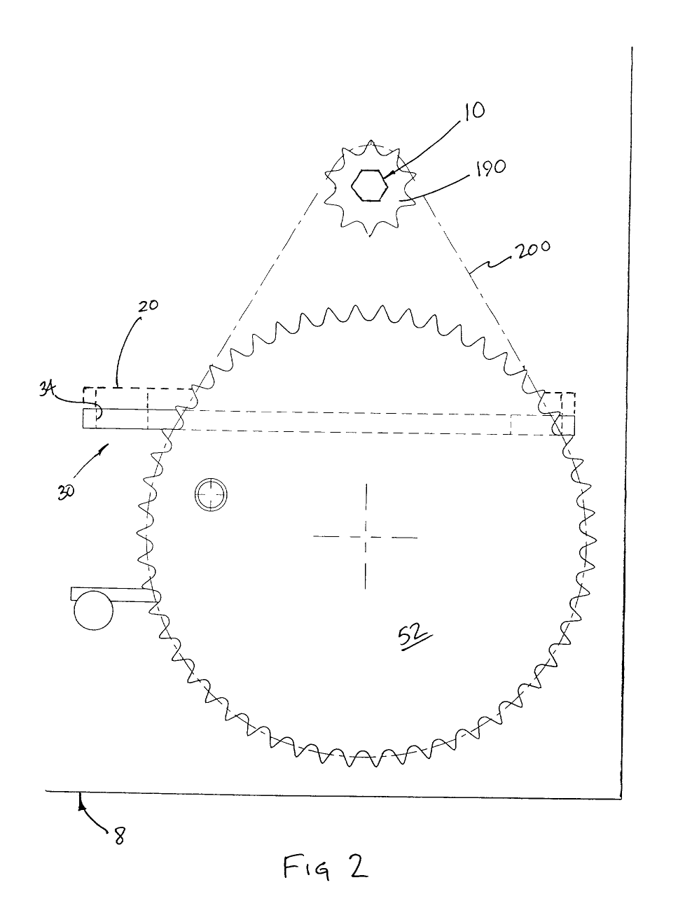

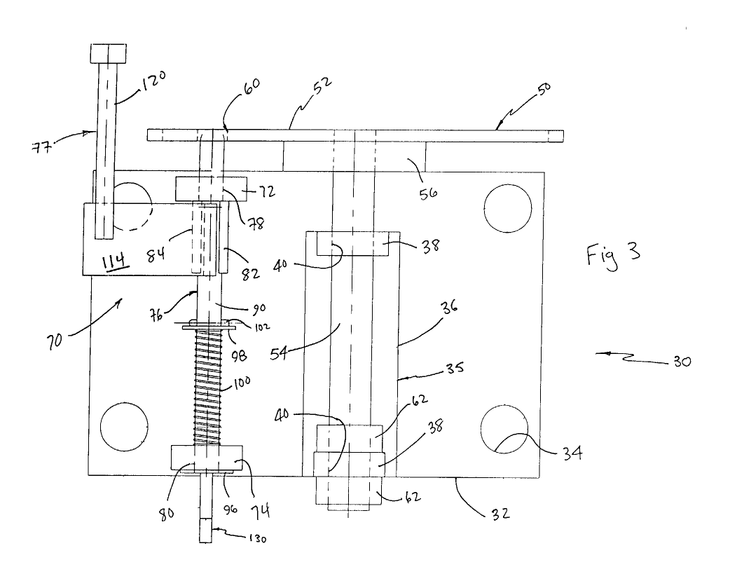

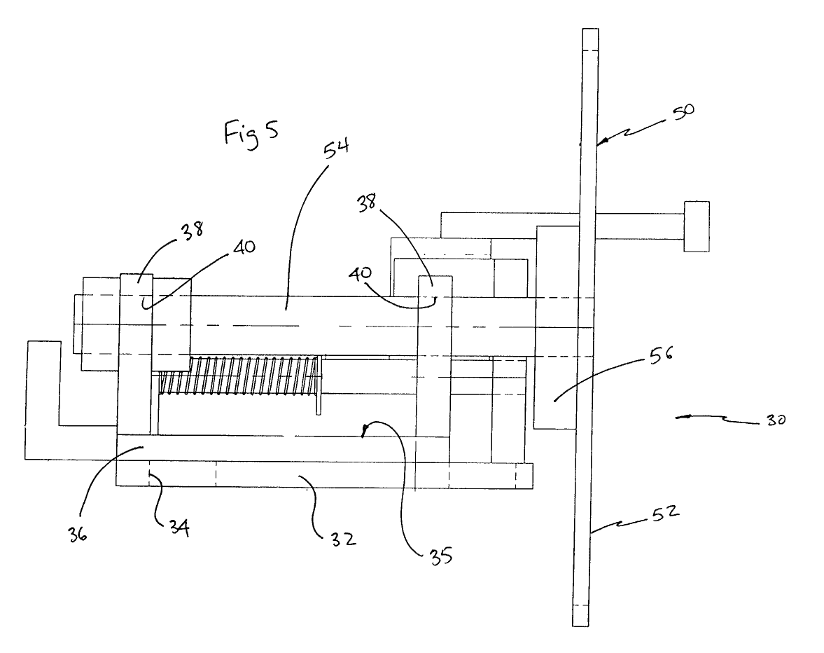

With reference now to FIG. 2, the manual override assembly is shown as including a base plate member 20 which exists in the present system, as well as crank member 10. It should be understood that crank member 10 has a hexagonal head as well as an elongate shank as will be described herein. With reference now to FIGS. 3-6, the safety device will be described in greater detail.

With reference first to FIG. 3, the safety device is shown generally at 30 and includes a base plate member 32 having a plurality of mounting apertures 34 in all comers thereof. The safety device includes a bearing assembly 35 having a pedestal 36 and further includes upstanding bearing blocks 38. The upstanding bearing blocks 38, each have aligned openings at 40, as described herein.

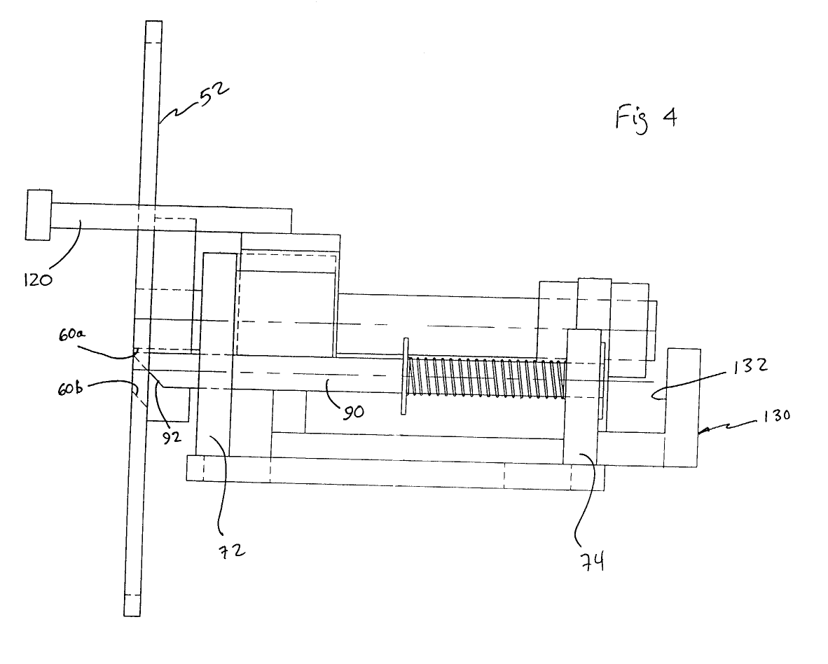

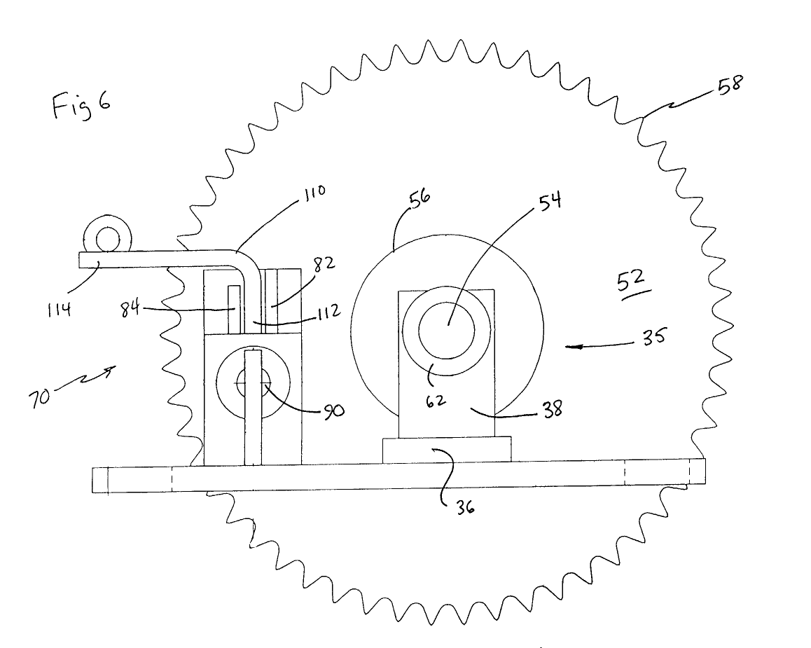

With reference still to FIGS. 3-5, the safety device 30 further includes a sprocket assembly 50 including a first gear or sprocket at 52 mounted to a rotatable shaft 54 by way of a collet 56. Sprocket 52 includes a plurality of sprocket teeth 58 as shown in FIG. 6, and an aperture 60, as shown best in FIGS. 3 and 4. Aperture 60 includes a locking shoulder at 60a and a beveled surface at 60b. Finally, locking collets 62 are mounted to the shaft and flank the upstanding bearing block 38.

With reference now to FIGS. 3 and 6, a locking mechanism is shown at 70 which generally comprises a locking plunger mechanism at 76, and a release mechanism at 77. The locking mechanism includes upstanding supports 72 and 74, each of which includes apertures 78 and 80 therethrough. Furthermore, support 72 includes a guide mechanism as shown best in FIGS. 3 and 6 as comprising upstanding plates 82 and 84. The locking plunger mechanism 76 is comprised of a plunger rod 90 having a leading edge at 92 as shown best in FIG. 4. The plunger rod 90 further includes stop washers 96 and 98, a compression spring 100 and a lock or cotter pin at 102.

With reference now to FIGS. 3-6, the release mechanism will be described. The release mechanism 77 first includes an L-shaped bracket 110 mounted to the rod 90 by way of a vertical arm 112, with a horizontal arm 114 extending away from the rod 90 and outside of the periphery of sprocket 52 as best shown in FIG. 6. A release member 120 is attached to the horizontal portion of bracket 110 and extends forwardly of sprocket 52. Finally, and as best shown in FIG. 4, a stop bracket 130 is provided extending rearwardly from upstanding support 74 and is L-shaped in configuration to include an inwardly facing stop surface 132 opposed from the rod 90 as best shown in FIG. 6.

With reference to all of FIGS. 2-6, the assembly of the safety device 30 will now be described in greater detail. It should first be understood that all the components of the safety device as described above are comprised of a high strength structural steel so as to include the ruggedness and durability required in a secure facility. As such, structural components such as the base plate 32, pedestal 36, upstanding bearing block 38, and upstanding supports 72, 74 are cut or sheared from high grade steel plate of substantial thickness, on the order of ⅜inch to ⅝inch. Furthermore, due to the size and strength of the steel involved, preferably such items as pedestal 36 is welded to base plate 32, and in turn, bearing blocks 38 are welded to pedestal 36. Likewise, upstanding supports 72, 74 are welded to base plate 32. Guide plates 82, 84 are also welded to the backside of upstanding plate 72 and the end of vertical plate portion 112 is welded to the plunger rod 90. As such, the assembly of the entire safety device can be described as follows.

The locking assembly 76 is first assembled between the blocks 72 and 74. This could be accommodated in a number of ways depending upon the manufacturing process of choice. For example, the L-shaped bracket 110 could be welded to the rod 90 and all of the washers 96, 98, spring 100, etc., positioned within the upstanding supports 72, 74, and then placed on the base plate 32 welding the supports 72 and 74 to the base plate. Alternatively, the assembly scheme could be similar to the above, but the base plate 72, 74 could be bolted to the base plate 32. Also, the upstanding post 72, 74 could be split along a horizontal center line through the apertures 78, 80 such that the entire assembly could be placed into aperture 78, 80 of the upstanding post 72, 74 and then a bearing cap placed over the rod, and bolted in place, keeping the shaft in place. These and several other versions of manufacturing and assembly should be appreciated to one of ordinary skill in the art. Once the plunger assembly 76 is assembled as discussed, the sprocket assembly 50 can be positioned by inserting the shaft 54 through aperture 40 and into a first collet 62 on the inside of the upstanding bearing block 38. Continued movement of the shaft 54 through the opening 40 positions a portion of the shaft 54 on the opposite side of the upstanding bearing block 38. Another collet 62 is placed on the outside of post 38 such that the two collets span or flank bearing block 38 holding the shaft 54 in axial position relative to the upstanding bearing block 38.

With the device described above, and with reference to FIG. 2, the assembly 30 is mounted to the existing bracket 20 within the manual override assembly with apertures 34 aligned with existing apertures in plates 20. The plates 20, 32 can be then bolted in place, which places sprocket 52 forward of plate 32 as shown in FIG. 2. The existing crank mechanism 10 is removed from the existing manual override system, which has a shank extending from the hexagonal head, and a second sprocket 190 having an aperture which is slidable over the shank is welded to the shank of hexagonal crank mechanism 10. Replacing the combination of the crank mechanism 10 and the sprocket 190 will place sprockets 190 and 52 in the same plane.

Crank mechanism 10 should be then rotated to the first select position, that is, to the position allowing the individual cell doors to be individually keyed open. Sprocket 52 is thereafter rotated to the position where rod 90 is positioned in aperture 60. In this position a chain 200 which meshes with both sprockets 190 and 52 is linked together such that crank mechanism 10 will drive sprocket 190 and in turn sprocket 52. Crank mechanism 10 is then returned to the fully operational mode, that is counter rotated three revolutions, where it will run in full electric mode. It should be noted that in the counter rotation mode, leading edge 92 of the rod 90 will be cammed open against the surface 60b of the opening 60 but will be generally spring loaded against the backside of sprocket 52.

In the preferred embodiment of the invention, the sprockets 190 and 52 are chosen such that the ratio is approximately 5 to 1. As viewed from FIG. 2, this is achieved with sprocket 52 having 54 teeth and sprocket 190 having 10 teeth. The purpose for the ratio is that the crank mechanisms vary somewhat and the ratio should be between the number of revolutions for the first and second select positions. Said differently, in at least one version of manual override system, the crank mechanism 10 is rotated three revolutions to move to the first select position, where the cell doors can be individually keyed open. The crank mechanism 10 can be rotated another four full revolutions or to seven revolutions to a position where all doors are free to open. The gearing between sprocket 190 and 52 should be such that sprocket 52 need not rotate a full revolution to the locked position, but the gearing must be less than the higher number of revolutions of the crank mechanism 10, in this case seven.

Thus, in the operational mode, if electricity is lost, the crank mechanism 10 is rotated such that cable 12 is tensioned to pull the unlocking mechanism within channel 14. However, the crank mechanism 10 can only be rotated to the position where rod 90 snaps into place in aperture 60. Continued rotation of the crank mechanism is not possible as the rod 90 abuts locking surface 60a preventing further rotation. However, further continued rotation is possible by pushing plunger 120 to the right as viewed in FIG. 4 to disengage rod 90 from aperture 60.

It should be appreciated to one skilled in the art that various different linkages are possible, that a gear drive could be arranged whereby instead of sprockets 190 and 52, gears could be arranged whereby gears directly or indirectly drive each other. Furthermore, it could also be appreciated that the gear or gears could be other than rotary. For example, gear 190 could be a rotary gear which drives for example a linear rack, whereby the rack moves along a horizontal axis and has a spring loaded rod which contacts in a side recess in the rack. Those skilled in the art could also achieve other various embodiments, while using the general concept of the invention as taught and claimed herein.

We claim:

1. A safety device for a secure prison cell, or the like, for use with a manual override cell unlocking device having a crank mechanism, which upon a first select number of rotations, allows individual doors to be unlocked, and upon continued rotation to a second select number of rotations, to unlock an entire cell run, the device preventing inadvertent unlocking of a plurality of cells in a cell run by over rotation of the crank, the device comprising a driven member cooperable with the crank mechanism, the safety device further comprising a lock mechanism cooperable with said driven member and having a locked position coinciding with the first select number of rotations of the crank mechanism, which locks said crank mechanism from further rotation, and a release member which allows the crank mechanism to be further rotated.

2. The safety device of claim 1, wherein said driven member is a gear member.

3. The safety device of claim 2, wherein said gear member is driven by said crank mechanism.

4. The safety device of claim 3, further comprising a drive gear coupled to said crank mechanism for driving said driven gear.

5. The safety device of claim 4, wherein said drive and driven gears are sprockets, with a chain in surrounding relation to said drive and driven sprockets.

6. The safety device of claim 4, wherein said drive gear and driven gear are rotary gears.

7. The safety device of claim 6, wherein the drive and driven gears are sized such that they are driven in a 5:1 ratio.

8. The safety device of claim 7, wherein said lock mechanism is spring loaded against said driven gear.

9. The safety device of claim 8, wherein said lock mechanism is comprised of a spring loaded member locked against a locking shoulder of said driven gear.

10. The safety device of claim 9, wherein said spring loaded member is a rod, spring loaded against said driven gear, and said locking shoulder is formed by an aperture through said driven gear, which receives said rod, when said rod and aperture are aligned.

11. The safety device of claim 1, wherein said lock mechanism is comprised of a spring loaded member locked against said driven member.

12. The safety device of claim 11, wherein said driven member is a driven gear, and said spring-loaded member is a rod, spring loaded against said driven gear.

13. The safety device of claim 12, wherein said driven gear has an aperture therethrough, which receives said rod, when said rod and aperture are aligned.

14. A secure prison cell, comprising:
a plurality of cells in a cell run, each said cell having a secure and slidable door;
a manual override cell unlocking device having a crank mechanism interconnected by way of a linkage assembly to said doors, said crank mechanism being operable so that upon a first select number of rotations, individual doors may be unlocked, and upon continued rotation to a second select number of rotations, said entire cell run is unlocked; and
a safety device cooperable with said crank mechanism for locking said crank mechanism upon reaching said first select number of rotations, preventing inadvertent unlocking of a plurality of cells in a cell run by over rotation of the crank mechanism.

15. The secure prison cell of claim 14, wherein said safety device comprises a driven member cooperable with the crank mechanism, the safety device further comprising a lock mechanism cooperable with said driven member and having a locked position coinciding with the first select number of rotations of the crank mechanism, which locks said crank mechanism from further rotation, and a release member which allows the crank mechanism to be further rotated.

16. The secure prison cell of claim 15, wherein said driven member is a gear member.

17. The secure prison cell of claim 16, wherein said gear member is driven by said crank mechanism.

18. The secure prison cell of claim 17, further comprising a drive gear coupled to said crank mechanism for driving said driven gear.

19. The secure prison cell of claim 18, further comprising a chain in surrounding relation to said drive and driven gears.

20. The secure prison cell of claim 18, wherein said drive gear and driven gear are rotary gears.

21. The secure prison cell of claim 20, wherein the drive and driven gears are sized such that are sized such that they are driven in a 5:1 ratio.

22. The secure prison cell of claim 21, wherein said lock mechanism is spring loaded against said driven gear.

23. The secure prison cell of claim 22, wherein said lock mechanism is comprised of a spring loaded member locked against a locking shoulder of said driven gear.

24. The secure prison cell of claim 23, wherein said spring loaded member is a rod, spring loaded against said driven gear, and said locking shoulder is formed by an aperture through said driven gear, which receives said rod, when said rod and aperture are aligned.

25. The secure prison cell of claim 14, wherein said lock mechanism is comprised of a spring loaded member locked against said driven member.

26. The secure prison cell of claim 25, wherein said driven member is a driven gear, and said spring-loaded member is a rod, spring loaded against said driven gear.

27. The secure prison cell of claim 12, wherein said driven gear has an aperture therethrough which receives said rod, when said rod and aperture are aligned.

28. A manual override assembly for a plurality of secure doors for a prison cell run, comprising:
a linkage assembly connected to said doors, having a first linear position allowing the doors to be manually unlocked, and a second linear position which unlocks all of the doors;
a crank mechanism interconnected to said linkage assembly, said crank mechanism being operable so that upon a first select number of rotations, said linkage assembly is pulled to said first position, and upon continued rotation to a second select number of rotations, said linkage is moved to said second linear position and the entire cell run is unlocked;
a safety device cooperable with said crank mechanism for locking said crank mechanism upon reaching said first select number of rotations, preventing inadvertent over rotation of said crank mechanism, and;
a release mechanism for unlocking said safety device and allowing for further rotation.

29. The manual override assembly of claim 28, wherein said safety device comprises a driven member cooperable with said crank mechanism, the safety device further comprising a lock mechanism cooperable with said driven member and having a locked position coinciding with the first select number of rotations of the crank mechanism, which locks said crank mechanism from further rotation.

30. The manual override assembly of claim 29, wherein said driven member is a gear member.

31. The manual override assembly of claim 30, wherein said gear member is driven by said crank mechanism.

32. The manual override assembly of claim 31, further comprising a drive gear coupled to said crank mechanism for driving said driven gear.

33. The manual override assembly of claim 32, wherein said drive gear and driven gear are rotary gears.

34. The manual override assembly of claim 33, wherein the drive and driven gears are sized such that are sized such that they are driven in a 5:1 ratio.

35. The manual override assembly of claim 32, wherein said lock mechanism is spring loaded against said driven gear.

36. The manual override assembly of claim 35, wherein said lock mechanism is comprised of a spring loaded member locked against a locking shoulder of said driven gear.

37. The manual override assembly of claim 36, wherein said spring loaded member is a rod, spring loaded against said driven gear, and said locking shoulder is formed by an aperture through said driven gear, which receives said rod, when said rod and aperture are aligned.

38. The manual override assembly of claim 28, wherein said lock mechanism is comprised of a spring loaded member locked against said driven member.

39. The manual override assembly of claim 38, wherein said driven member is a driven gear, and said spring-loaded member is a rod, spring loaded against said driven gear.

40. The manual override assembly of claim 39, wherein said driven gear has an aperture therethrough which receives said rod, when said rod and aperture are aligned.
